(19) United States
(12) Patent Application Publication
(10) Pub. No.: US 2005/0023801 A1
(43) Pub. Date: Feb. 3, 2005

(54) Fin-ray tote-a-load

(76) Inventor: Adley Finley, Missouri City, TX (US)

Correspondence Address: Adley Finley, 16727 Quail Park, Missouri City, TX, 77489, US

(21) Appl. No.: 10/425,040

(22) Filed: Jul. 31, 2003

(51) Int. Cl. B62B 1/00

(52) U.S. Cl. 280/656

(57) ABSTRACT

The invention called the Fin-Ray Tote-A-Load is a wheelchair attachment. This attachment is designed to push a wheelchair with a person sitting in it. It enables you to steer the chair and stop the chair while also carrying luggage, flowers, charts, etc. It is capable of carrying up to 250 lbs. It is a fold down unit that can quickly attach and detach from the wheelchair. This attachment is safe as well as durable. It is designed to fit most wheelchairs. This invention can be used at hospitals, airports, shopping malls, nursing homes, as well as the comfort of your own home.

The invention called the Fin-Ray Tote-A-Load is a wheelchair attachment. This attachment is designed to push a wheelchair with a person sitting in it. It enables you to steer the chair and stop the chair while also carrying luggage, flowers, charts, etc. It is capable of carrying up to 250 lbs. It is a fold down unit that can quickly attach and detach from the wheelchair. This attachment is safe as well as durable. It is designed to fit most wheelchairs. This invention can be used at hospitals, airports, shopping malls, nursing homes, as well as the comfort of your own home.

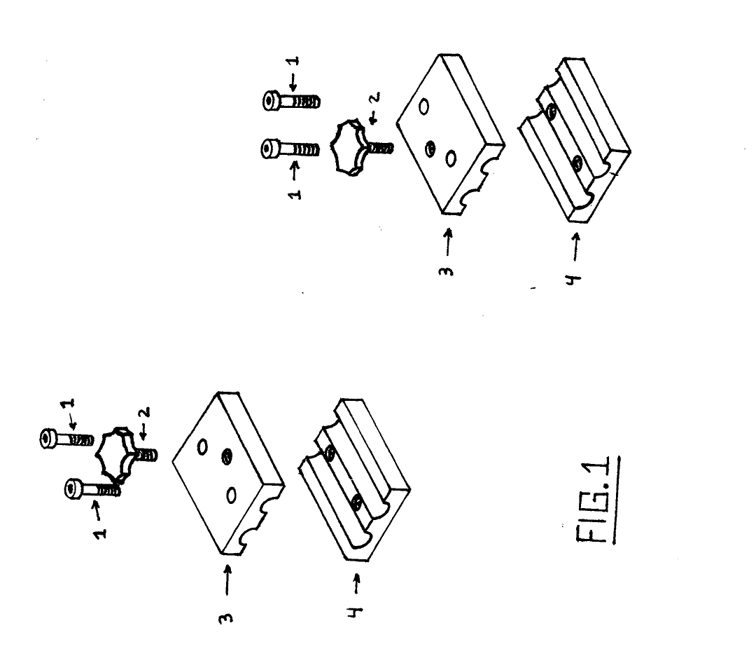

FIG. 1 Perspective View

_{3&4} Shows brackets that attach the Tote-A-Load unit to the tubes that are located on the rear frame of the wheelchair. These brackets are made smaller than the tubes which cause a tight fit. ₂ The turn knob is for quick release.

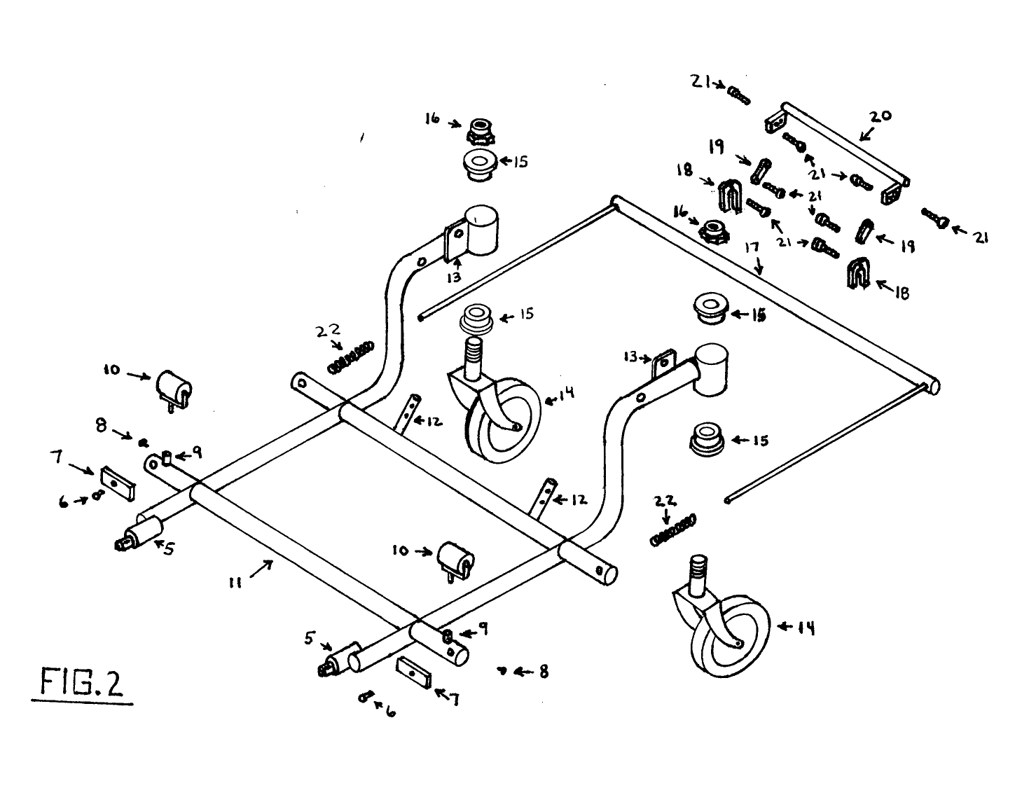

FIG. 2 Perspective View

Shows bottom frame of Tote-A-Load, brake parts that lock the rear wheels of the wheelchair. _{14&15} It shows the rear wheels that swivel and the bearings that fit on the bottom and top of the fork for the casters. _{11,14,15 10} Roller which allows rear wheels of wheelchair to continue to roll over small humps. ₇ Brake pads to stop wheelchair from rolling. ₉ Receptacle for roller. ₂₂ Springs that make brake recoil. ₅ Insert into brackets that attach Tote-A-Load to wheelchair. ₂₀ Brake bar that when compressed locks and unlocks rear wheels of wheelchair. ₁₇ Flex bar inserts into frame that have the brake pads attached to the end to lock rear wheels of wheelchair. ₁₂ Holds brake bar in place. ₁₃ Holds push handle in place. ₁₆ Bolt that attaches caster to frame. ₆ Screw that connects brake pad to flex bar. ₁₂ Mounting bars for brake system.

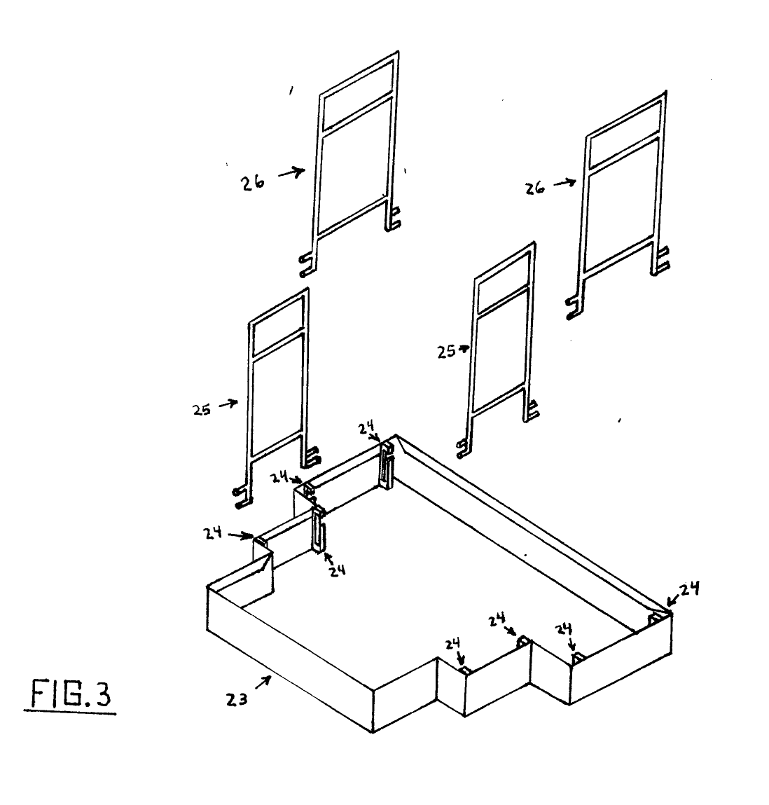

FIG. 3 Perspective View

₂₃ Basket that attaches to frame that will hold articles that are placed into it. _{25&26} Fold downside racks that prevent articles from falling to floor and prevent rear wheels from touching articles in the basket. ₂₄ Hold racks in place.

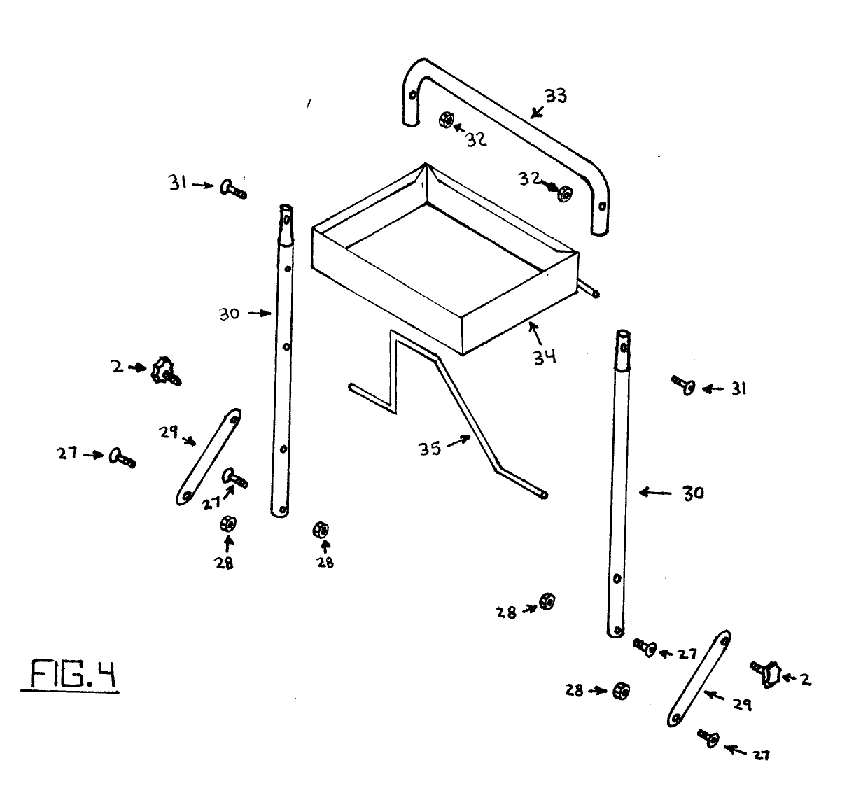

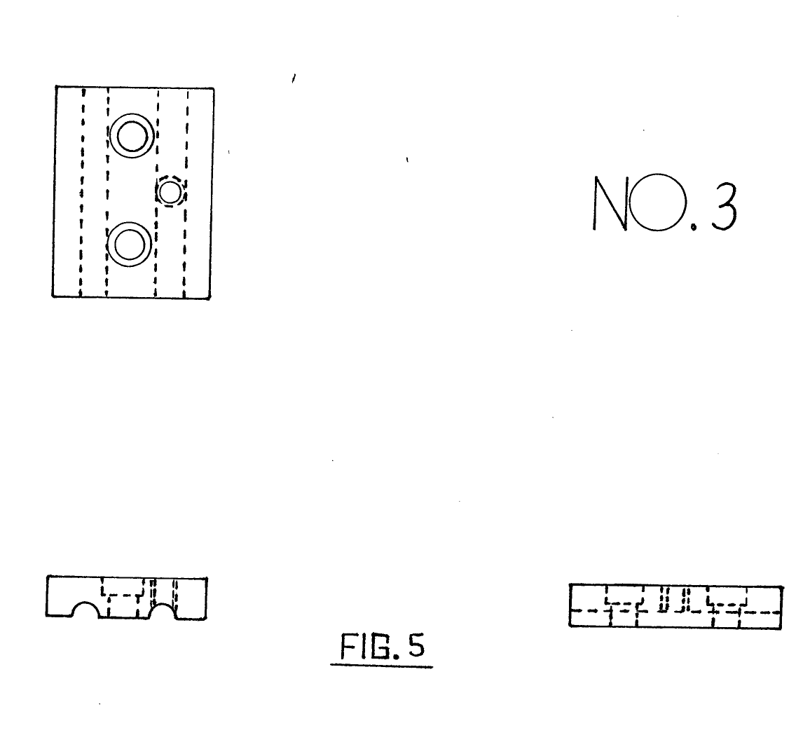

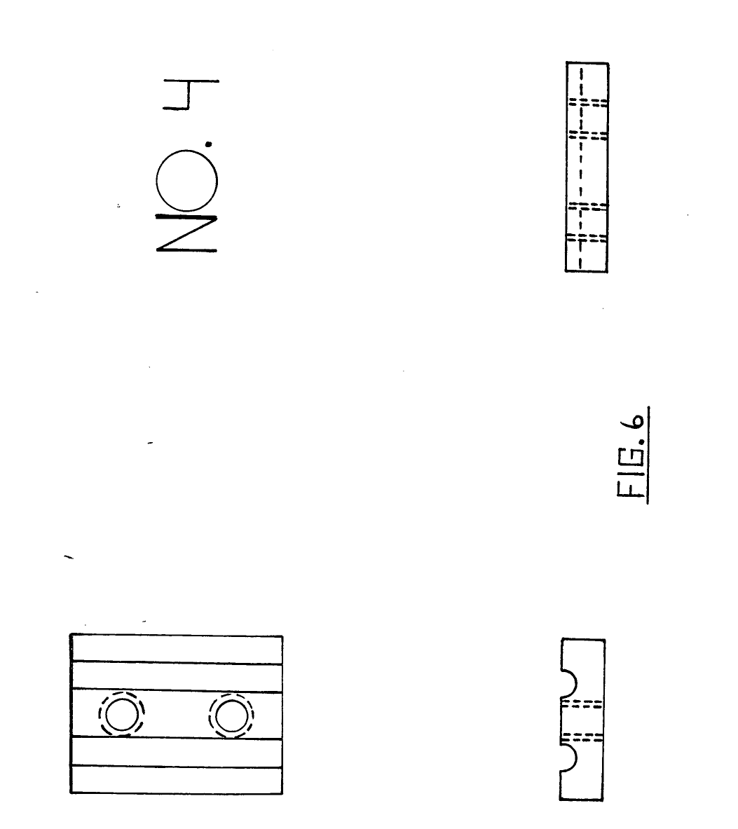

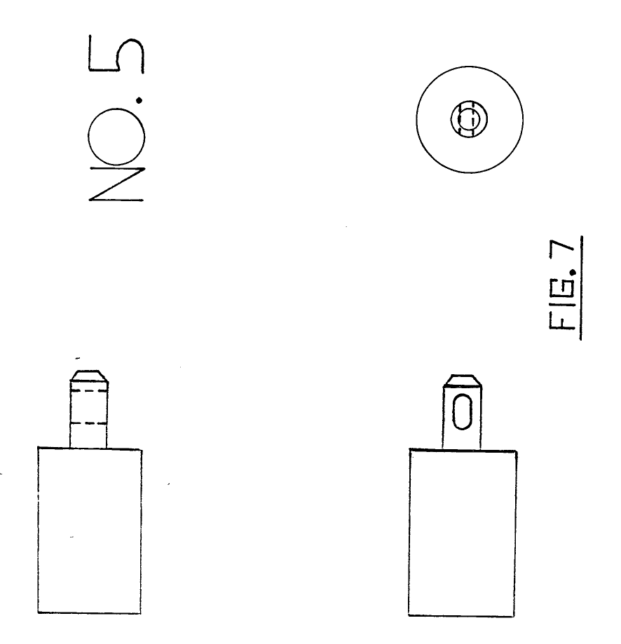

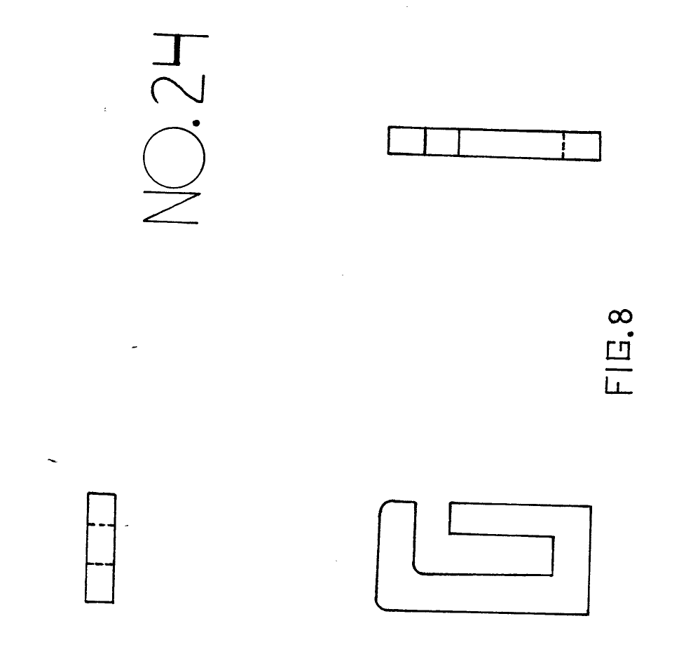

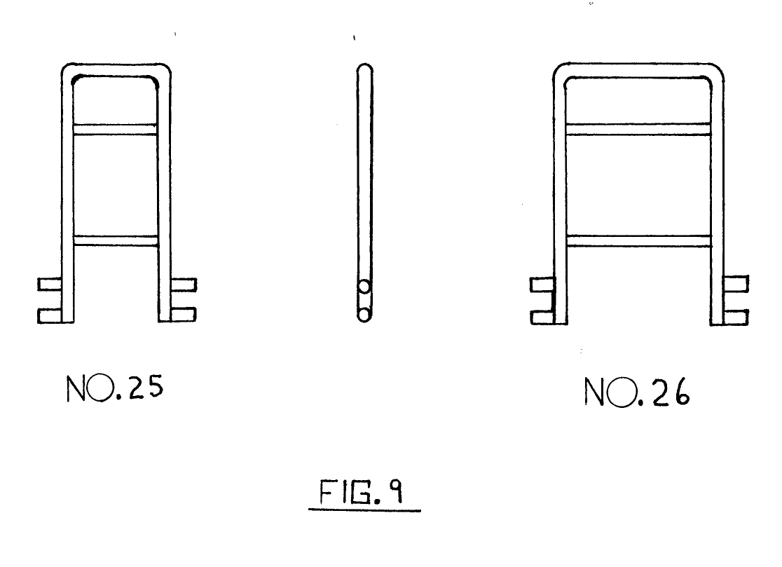

FIG. 4 Perspective View

_{30&33} Shows push handle assembly. ₃₄ Flower Tray. ₃₅ V bar which holds flower tray. ₂₉ Collapse bar which allows push handle bar to fold down. ₂ Quick release knob.

FIG. 5 Shows bracket that attaches wheelchair to Tote-A-Load

FIG. 6 Shows bracket at another angle

FIG. 7 show frame insert

FIG. 8 Reveals view points of rack holders

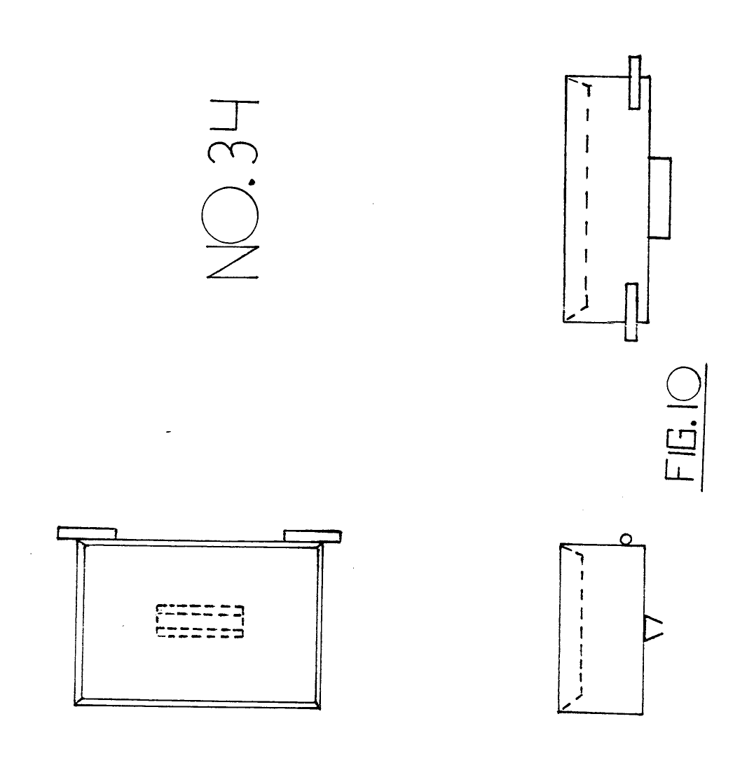

FIG. 9 view points of fold down racks

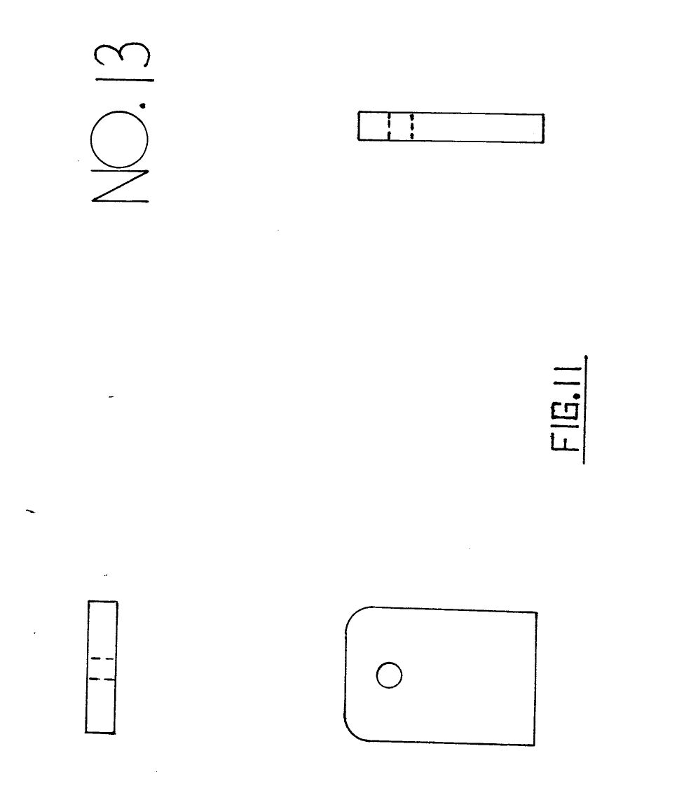

FIG. 10 View points of basket for flowers

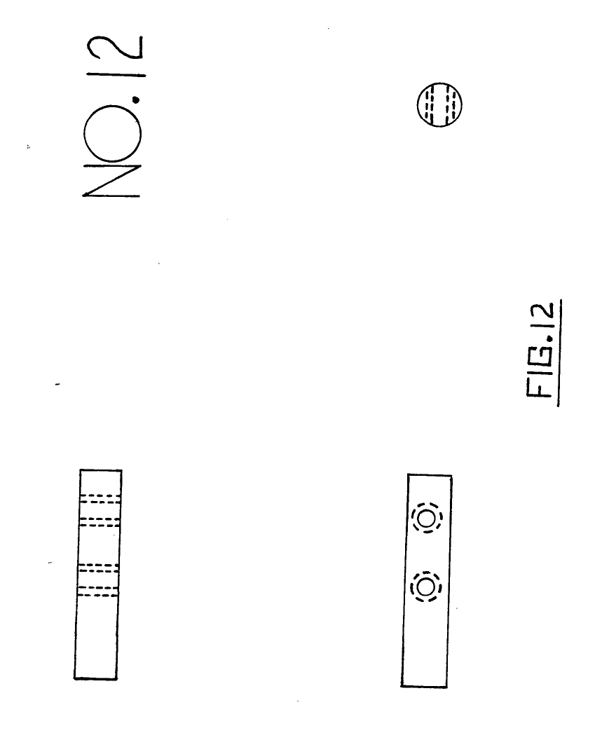

FIG. 11 Connects frame to push handles

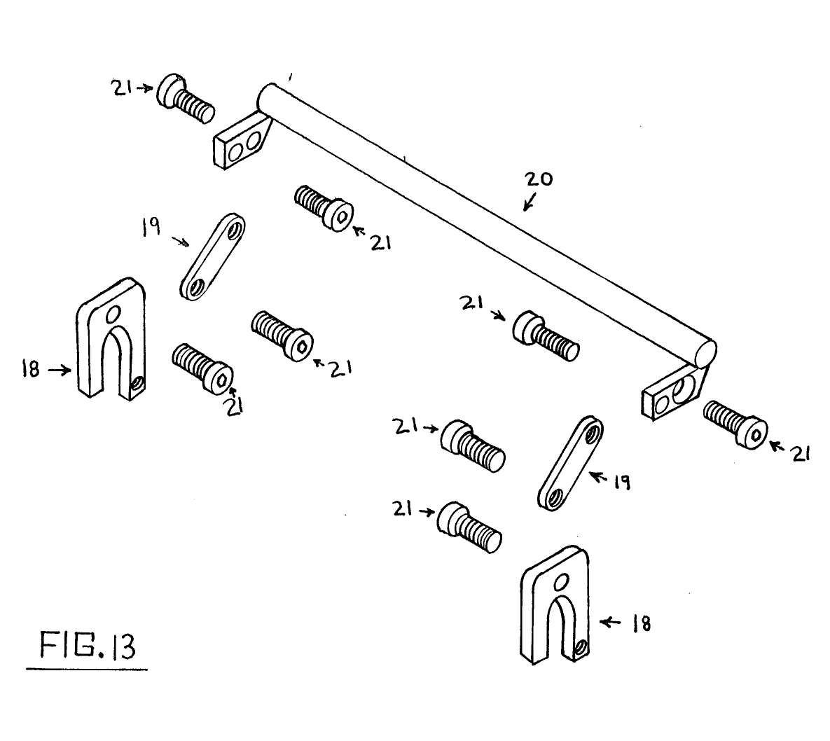

FIG. 13 Shows foot brake system that connects to frame, that presses against rear wheels to lock and unlock wheels. ₁₈ Shows U engage brackets. ₂₀ Shows foot paddle to engage and disengage brake. ₁₉ Brake bar. ₂₁ Cap screws 5/16.

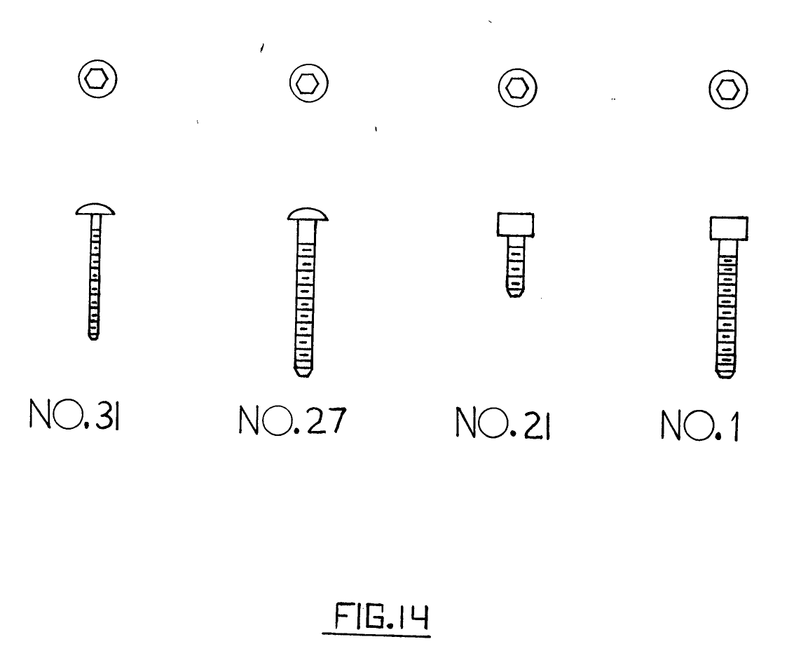

FIG. 14 Shows various screws that are used on the Tote-A-Load.

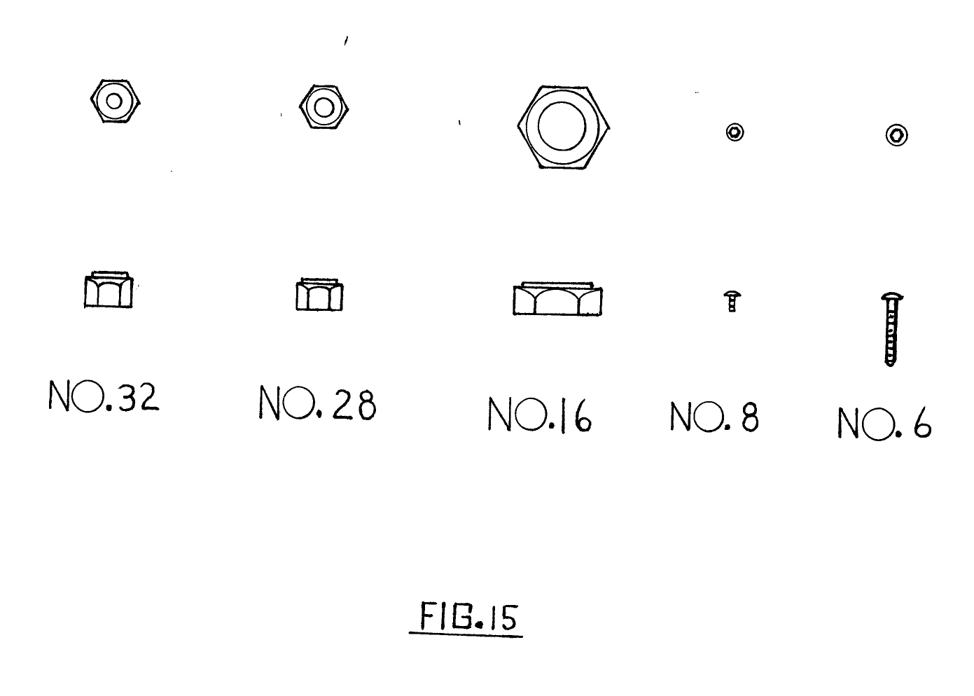

FIG. 15 Shows additional screws and nuts used for the Tote-A-Load.

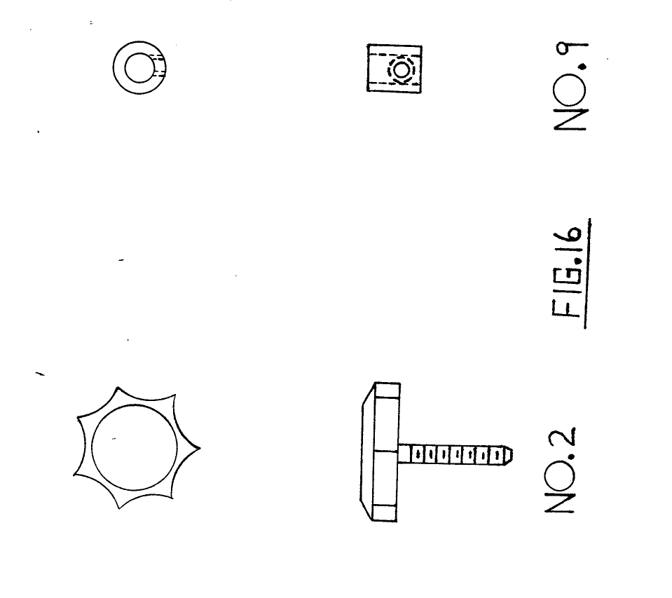

FIG. 16 Revels star knob—5/16″ that are quick release for folding down unit and release unit from wheelchair.

1. I, Adley Finley, claim the Tote-A-Load as my idea and invention. The product was developed to help hospital employees admit and discharge patients by being able to move them along with their luggage and other items they may have the product is designed to last and give years of service. This device has the capabilities to attach to most wheelchairs by using special designed brackets. It can carry up to 250 pounds. This product can also fold down for storage. The Tote-A-Load can free up personnel to do other duties. It requires very little maintenance if any.
